(19) United States
(12) Patent Application Publication
(10) Pub. No.: US 2014/0272527 A1
(43) Pub. Date: Sep. 18, 2014

(54) SEPARATOR COMPONENTS AND SYSTEM FOR ENERGY STORAGE AND CONVERSION DEVICES

(71) Applicants: Srinivasan Venkatesan, Bloomfield Hills, MI (US); Lin Higley, Troy, MI (US); Fabio Albano, Royal Oak, MI (US); Susmitha Gopu, Royal Oak, MI (US); Subhash K. Dhar, Bloomfield Hills, MI (US)

(72) Inventors: Srinivasan Venkatesan, Bloomfield Hills, MI (US); Lin Higley, Troy, MI (US); Fabio Albano, Royal Oak, MI (US); Susmitha Gopu, Royal Oak, MI (US); Subhash K. Dhar, Bloomfield Hills, MI (US)

(73) Assignee: Energy Power Systems, LLC, Troy, MI (US)

(21) Appl. No.: 13/843,373

(22) Filed: Mar. 15, 2013

(51) Int. Cl. H01M 2/16; H01M 2/14

(52) U.S. Cl. CPC H01M 2/1686; H01M 2/145
USPC 429/144; 429/142; 29/623.5; 427/58

(57) ABSTRACT

Components and systems for energy storage and conversion devices are disclosed. An exemplary system may include a positive electrode, a negative electrode, and a separator disposed between the positive electrode and the negative electrode for providing ionic transport. The system may also include a hydrophobic portion on the separator. The hydrophobic portion may comprise hydrophobic pathways formed on the surface of the separator. The system may also include a hydrophilic portion on the separator. Another exemplary system may include an absorptive glass mat separator having a hydrophobic portion and a textured PVC separator. An exemplary method may include manufacturing the separator and applying a hydrophobic portion on the separator. The method may also include applying a hydrophilic portion to the separator.

### RELATED APPLICATIONS

This application incorporates by reference the entire disclosure of U.S. application Ser. No. 13/350,505, entitled, “Improved Substrate for Electrode of Electrochemical Cell,” filed Jan. 13, 2012, by Subhash Dhar, et al., the entire disclosure of U.S. application Ser. No. 13/350,686, entitled, “Lead-Acid Battery Design Having Versatile Form Factor,” filed Jan. 13, 2012, by Subhash Dhar, et al., the entire disclosure of U.S. patent application Ser. No. 13/475,484, entitled “Lead-Acid Battery with High Power Density and High Energy Density,” filed May 18, 2012, by Subhash Dhar, et al., and the entire disclosure of U.S. patent application Ser. No. 13/626,426, entitled “Lead-Acid Battery Design Having Versatile Form Factor,” filed Sep. 25, 2012, by Subhash Dhar, et al.

### TECHNICAL FIELD

The present disclosure relates generally to improved separator components and system for use in energy storage and conversion applications. Specifically, the improved separator components and system of embodiments of the present disclosure employ hydrophobic properties to help control and facilitate the movement of trapped reaction by-products. This may facilitate recombination reactions thereby reducing cell pressure. In particular, the separator components and/or systems of the present disclosure may improve the performance of electrochemical and/or fuel cells.

### BACKGROUND

During charging of an electrochemical power source, hydrogen and oxygen are evolved by the electrolysis of water as an undesirable side reaction. It is desirable for the hydrogen and oxygen to recombine to replenish the water in the cell and minimize the amount of water lost. Hydrogen typically migrates into the head space above the electrode stack. If it does not exert sufficient pressure to open the vent, the hydrogen will remain in the cell. The buildup and venting of hydrogen may create a safety hazard.

Oxygen typically recombines with the negative active material. To reach the active material, however, oxygen must either diffuse through the electrolyte contained in the separator system to reach the negative active material, or migrate into the head space above the electrode stack and be transported to the surface of the negative electrode. If the pressure of gases in the cell exceeds the vent pressure, hydrogen and oxygen will vent and both will be lost from the cell. Because they are lost, the cell will lose an amount of water equivalent to the amount of oxygen and hydrogen lost through venting. This may cause the separator to dry out prematurely, causing resistance to increase and cell performance to deteriorate.

The electrode stack is compressed in a typical electrochemical cell. Although somewhat resilient, the separators also feel the effect of the overall compression applied to the stack. The separator, therefore, must have sufficient strength and mechanical integrity to withstand the compressive forces applied to the stack.

The separator serves as a reservoir for electrolyte in a starved cell. Thus, the separator must hold the required amount of electrolyte at all times. It must be able to wick away the water formed by recombination of hydrogen and oxygen. It must make electrolyte available at the right time and place and distribute electrolyte to the electrodes. It must also regulate the transfer of oxygen from the positive to the negative electrode. These several requirements favor the use of a hydrophilic separator.

These requirements, however, are not entirely consistent. The use of a hydrophilic separator slows and may impede the transfer of oxygen. Bubbles of oxygen tend to stick to hydrophilic surfaces and accumulate at the electrode separator interface. Thus, oxygen tends to be trapped on hydrophilic separator surfaces.

This effect may cause several problems. First, the existence and growth of a bubble may cause resistance to increase because the bubble displaces electrolyte and the bubble itself is not ionically conductive. Second, the area of active material at which the bubble is attached is blocked from access to electrolyte and unable to react. This in turn causes internal resistance to increase. It also causes loss of capacity and power of the portion of active material at which the bubble is attached. Third, the growth of bubbles may distend the active material and/or separator, weakening its integrity, undermining the mechanical integrity of the electrode structure, and hindering cycle life. Eventually the bubble will burst. The burst pressure may cause the active material to shed at the contact point with the bubble.

Thus, there is a need for techniques to prevent bubbles from forming and accumulating to the point where they cause the above-referenced problems. This would improve power delivery and extend battery life. By managing the gases and facilitating recombination of hydrogen and oxygen these techniques would increase safety and performance.

### SUMMARY

In one aspect of the disclosure, an electrochemical cell comprises a positive electrode and a negative electrode. The electrochemical cell also comprises a separator disposed between the positive electrode and the negative electrode for providing ionic transport. The electrochemical cell further comprises a hydrophobic portion on the separator.

In another aspect of the disclosure, a method of forming a separator for use in an electrochemical cell comprises manufacturing the separator and applying a hydrophobic portion on the separator. In one embodiment, the method further includes masking the separator with a patterned template and applying a hydrophobic solution over the masked separator. In another embodiment, the method includes stitching hydrophobic strips to the separator. In another embodiment the entire separator is immersed in a diluted hydrophobic solution to enhance hydrophobic areas. In another embodiment, the method includes applying a hydrophilic portion to the separator.

In yet another aspect of the disclosure, a method of manufacturing an electrochemical cell comprises manufacturing a positive electrode, a negative electrode, and a separator. The method further includes forming hydrophobic pathways on the separator and placing the separator between the positive electrode and the negative electrode.

In another aspect of the disclosure, a separator comprises a hydrophobic portion on the separator. In yet another aspect of the disclosure, a separator system comprises a separator having a hydrophobic portion. In an embodiment, the separator system includes a textured PVC separator. In another embodiment, the separator system includes two absorptive glass mat separators with hydrophobic pathways and a textured PVC separator in between the two absorptive glass mat separators. In yet another embodiment, the separator system includes two absorptive glass mat separators with hydrophobic pathways and strips of textured PVC separator in between the two absorptive glass mat separators. In a further embodiment, the separator system includes two textured PVC separators with strips of absorptive glass mat separator with hydrophobic pathways in between the two textured PVC separators.

In yet another embodiment of the invention, an absorptive glass mat separator is completely immersed in a diluted hydrophobic solution, excess solution drained, thus forming uniformly distributed hydrophobic areas within the separator further processed and used.

In yet another aspect of the disclosure, a storage device comprises a positive electrode, a negative electrode, and a separator disposed between said positive electrode and said negative electrode for providing ionic transport. The storage device further includes a hydrophobic portion on said separator.

Some embodiments of the present disclosure prevent or at least inhibit water loss due to venting of evolved gases. This may enhance performance and increase cycle life. By retaining the hydrogen and oxygen in the cell, the gases are permitted to recombine at the negative plate reforming water molecules. Water molecules are reabsorbed by the separator system and distributed to the electrodes. Retention of water restores the desired specific gravity of the electrolyte, preferably maintaining it within design limits.

Further, in some embodiments, the effective recombination is exothermic resulting in a temperature rise in the cell. This may produce favorable reaction kinetics that may enhance performance of the cell.

### BRIEF DESCRIPTION OF THE DRAWINGS

FIG. 1A depicts a schematic diagram of an exemplary electrochemical cell according to an embodiment of the present disclosure.

FIG. 1B depicts a schematic diagram of another exemplary electrochemical cell according to an embodiment of the present disclosure.

FIGS. 2A and 2B illustrate a functionality of exemplary electrochemical separators according to various disclosed embodiments.

FIG. 3 is a graph depicting discharge capacity as a function of cycle number of a separator of an embodiment of the present disclosure.

FIG. 4A is a schematic diagram of a process for making an embodiment of the present disclosure using a PTFE solution as a hydrophobic coating.

FIG. 4B is schematic diagram of a process for making an alternative embodiment of the present disclosure using microporous polypropylene separator strips as a hydrophobic coating.

FIG. 5A is a flowchart of the process shown in FIG. 4A.

FIG. 5B is a flowchart of the process shown in FIG. 4B.

FIGS. 6A-6C are exploded schematic diagrams of partial sections of electrochemical cells according to some embodiments of the present disclosure.

### DETAILED DESCRIPTION

Reference will now be made in detail to exemplary embodiments of the present disclosure, examples of which are illustrated in the accompanying drawings. Whenever possible, the same reference number will be used throughout the drawings to refer to the same or like parts.

Embodiments of the present disclosure generally relate to electrochemical cells utilizing separators with hydrophobic pathways. The hydrophobic pathways may provide exit pathways for gas bubbles and promote recombination of gases evolved at the electrodes of the electrochemical cell, thereby improving power delivery and extending battery life, for example.

FIG. 1A depicts electrochemical cell 10 in a charging state, where positive electrode 12 releases electrons and negative electrode 14 receives electrons. A current may thereby be delivered to a load connected to positive electrode 12 via lead 13 and to negative electrode 14 via lead 15. In the example of a lead-acid electrochemical cell, positive electrode 12 may comprise lead oxide (PbO₂) as the active material, and negative electrode 14 may comprise sponge lead (Pb) as the active material. Separator 16 provides physical and electrical separation between positive electrode 12 and negative electrode 14. Separator 16, however, is porous and allows for ionic conduction, which completes the electrical circuit between positive electrode 12 and negative electrode 14.

During the charging process, gas is evolved through electrolysis. Oxygen gas evolves from the positive electrode and transits, either through the separator or through the overhead space above the electrode stack and recombines at the negative electrode. The use of hydrophilic separators reduces the diffusion of oxygen through the separator since oxygen has to dissolve and diffuse through a longer electrolyte pathway and may impair or impede the gas recombination process.

Gas recombination can be an important factor in prolonging battery life. During operation, an electrochemical cell generates gases that need to recombine. FIG. 1A illustrates the gas generation and recombination in an exemplary electrochemical cell 10 according to various embodiments of the present disclosure. In some embodiments, electrochemical cell 10 may be a lead-acid electrochemical cell.

In certain embodiments of the present disclosure, separator 16 may comprise absorptive glass mat (AGM). An AGM separator may be made from micro-porous glass microfibers. Such separator 16 may comprise an electrolyte that is immobilized by absorption within the glass microfibers. In some embodiments, separator 16 is compressed against the surfaces of electrodes 12 and 14. At the interface between separator 16 and electrodes 12 and 14, the electrolyte reacts with the active materials, e.g., PbO₂ and Pb, to build up or discharge electric potential. As an example, in lead-acid batteries and according to some embodiments, the electrolyte may comprise an aqueous mixture of Sulfuric acid (H₂SO₄) and water. The reaction at positive electrode 12 may be characterized by equation (1):

$${PbO}_{2} + 3 {H}^{+} + {HSO}_{4}^{-} + 2 e {{⇌}_{charge}}^{discharge} 2 {H}_{2} O + {PbSO}_{4} \qquad ( 1 )$$

And the reaction at negative electrode 14 may be characterized by equation (2):

$$Pb + {HSO}_{4}^{-} {{⇌}_{charge}}^{discharge} {PbSO}_{4} + {H}^{+} + 2 e , \qquad ( 2 )$$

As seen in equations (1) and (2), during charging or recharging of electrochemical cell 10, lead sulfate (PbSO₄) is electrochemically converted to PbO₂ on positive electrode 12 and Pb on negative electrode 14.

As electrochemical cell 10 approaches full charge and the majority of PbSO₄ has been converted to the active materials, gas evolution reactions may occur. When gas evolution reactions occur, oxygen gas (O₂) may be formed on positive electrode 12, hydrogen gas (H₂) may be formed on negative electrode 14, or both. The overcharge reaction on the positive electrode 12 may be characterized by equation (3):

2H₂O→4H⁺4e⁻+O₂ (3)

The overcharge reaction on negative electrode 14 may be characterized by equation (4):

2H⁺+2e⁻→H₂. (4)

In various embodiments, the porous structure of separator 16 may allow for oxygen gas to pass through from positive electrode 12 to negative electrode 14. Oxygen gas that arrives at negative electrode 14 may recombine with hydronium ions (H₃O⁺) and generate water. For example, the oxygen gas may undergo a recombination reaction at negative electrode 14 according to equation (5):

[symbol]

2Pb+2HSO₄⁻+2H⁺O₂ [symbol] 2PbSO₄+2H₂O (5)

Maintaining the battery at a high efficiency requires efficient recombination of the generated oxygen. The rate of recombination of oxygen, however, may be limited by the diffusion rate of oxygen through the electrolyte in separator 16. If oxygen gas is generated but not promptly recombined, cell pressure may rise. In some situations, the buildup of gases may cause gas bubbles to displace electrolyte. As a result, the local cell electrical resistance may increase.

The gas bubbles may also interfere in the interface between active materials on electrodes 12 or 14 and the electrolyte, and block access to the active material, rendering portions of the active material unusable. Further, when oxygen gas remains trapped at the interface between positive electrode 12 and separator 16, oxygen gas may react with the acidic electrolyte to re-form water at the positive electrode. Consequently, water may be retained inside the pores of positive electrode 12 and contribute to “cell polarization,” which reduces the effectiveness of electrochemical cell 10. Such polarization effects may internally consume part of the electrochemical energy of the electrochemical cell. In some situations, cell pressure may increase with continued generation of gases until a pressure threshold is reached and vent valve 17 opens to vent the excess gas. Such venting may reduce the amount of water inside the electrochemical cell, eventually causing the electrolyte to dry out and the cell to fail. In addition, during venting, external impurities may enter electrochemical cell 10 through open vent valve 17. Therefore, it is desirable to prevent gas accumulation in electrochemical cell 10 by enhancing gas recombination.

In various embodiments, the tendency for gas bubbles to become trapped at the interface of separator 16 with positive or negative electrode may depend on the extent of cell compression, contact angle of the bubble at interface surfaces, and wettability of the interface. In some embodiments of the present invention, separator 16 may comprise a hydrophobic surface to aid in gas management, i.e. the removal of gases from the site at which they were evolved, migration of the evolved gases, and transfer of the evolved gases to their recombination site.

Hydrophobic surfaces minimize the contact area with a liquid such as water. FIG. 2A demonstrates the concept of hydrophobicity of a water bubble in air on a hydrophobic surface according to some embodiments. FIG. 2A shows contact area minimization of water bubble 20 in contact with a hydrophobic surface 22. Water bubble 20 adopts a near-spherical shape to reduce the contact area between the water bubble 20 and the hydrophobic surface 22. As a result, contact angle 24 between water bubble 20 and a hydrophobic surface 22 is relatively large. Contact angle 24 is defined as an angle between the surface of the liquid and the contact plane at the contact location. In particular, the surface of a curved surface can be defined by a tangent plane.

FIG. 2B also demonstrates the general concept of hydrophobicity according to some embodiments. FIG. 2B shows a gas bubble 27 trapped between water 25 and solid 26. Solid 26, has two areas, a hydrophobic region 26a and a hydrophilic region 26b. Gas bubble 27 is trapped between water 25 surrounding it and the hydrophobic surface 26a. The contact angle 25 of gas bubble 27 may be the supplementary angle to contact angle 24 in FIG. 2A. In FIG. 2B, the contact surface between water 25 and hydrophobic surface 26a is minimized and the contact surface between gas bubble 27 and hydrophobic surface 26a is maximized. Gas bubble 27 within an aqueous medium 25 may be preferentially displaced onto a hydrophobic surface. Rather than gas bubbles 27 being distributed randomly across the entire surface of solid 26, gas bubbles 27 tend to tend to migrate towards and accumulate on the hydrophobic regions 26a.

These concepts illustrate the operation of a separator of an embodiment of the present disclosure. Incorporation of hydrophobic regions on the surface of the separator may enable gas bubbles of oxygen evolved in the cell, to travel on hydrophobic regions 26a.

In an embodiment, a hydrophobic material may be applied to the surface of the separator to create hydrophobic regions on the surface of the separator. Hydrophobic regions may be applied to the separator by any of a number of different techniques. These may include soaking the separator, applying a coating to the surface of the separator, applying strips of hydrophobic material, or other application methods. Following application of the hydrophobic material, in certain embodiments the separator material preferably is dried and sintered. Various embodiments use different application methods.

In some embodiments, the bulk of the separator 16 material is soaked in a hydrophobic medium. The hydrophobic medium may comprise, for example, polytetrafluoroethylene (also referred to as PTFE or Teflon), polydimethylsiloxane, polyvinylidine fluoride, polyvinylchloride, or any other hydrophobic medium. Soaking the bulk material causes the surface of the separator pores to become hydrophobic. In some embodiments, over-application of hydrophobic material by soaking may render the separator inoperative. In some other embodiment, the amount of hydrophobicity introduced in the bulk may be adjusted such that micro-capillaries are formed, leading to an increase in the amount of electrolyte absorbed. Some embodiments, therefore, control the degree of hydrophobicity to ensure that ionic transfer through the separator is not prevented. The degree of hydrophobicity may be controlled by the dilution of the hydrophobic material in the soaking solution, the time of soaking, soaking conditions, and temperature and the time of sintering.

In some embodiments, only portions of the surface of separator 16 may be treated with a hydrophobic material.

FIG. 1A shows hydrophobic pathways 18 formed on the surface of separator 16. In an embodiment, hydrophobic pathways 18 may be on one or both surfaces of the separator facing the positive and/or the negative electrodes. In some embodiments, hydrophobic pathways 18 are formed as strips of continuous hydrophobic coating along a length of separator 16. In alternative embodiments, hydrophobic pathways 18 may be discontinuous islands of hydrophobic coating, or any other appropriate shape or geometry. In some embodiments, the hydrophobic regions are formed to provide an effective migration pathway for the evolved gases.

As shown in FIG. 1A, oxygen gas generated at positive electrode 12 may be guided towards hydrophobic pathways 18, by the surface tension of the aqueous electrolyte solution as it interacts with hydrophobic pathways 18. Once oxygen gas reaches a point on a hydrophobic pathway 18, the oxygen gas will encounter less resistance along the hydrophobic pathways 18. Oxygen gas will migrate toward the edge of positive electrode 12. Oxygen gas may then diffuse onto negative electrode 14 and recombine to produce water. As shown in FIG. 1A, separator 16 may also comprise hydrophobic pathways 18 along the side proximal to negative electrode 14. These pathways may further guide the oxygen gas towards negative electrode 14.

In various embodiments, addition of hydrophobic pathways 18 improves the performance of the electrochemical cell. For example, the hydrophobic pathways may increase the rate of recombination at negative electrode 14 of oxygen gas generated by positive electrode 12. Increased recombination decreases the number of trapped gas bubbles and increases the performance and life of the cell.

FIG. 1B shows an electrochemical cell 10 which further includes hydrophilic elements 67 and 69. In some embodiments, hydrophilic elements 67 and 69 may be thin layers, e.g., with a thickness between 100-250 micrometers, disposed on positive electrode 12, negative electrode 14, or both. Hydrophilic elements 67 and 69 may enhance hydrophilic properties of electrodes 12 and 14. An exemplary hydrophilic element 67 or 69 may be a pasting paper having hydrophilic properties. In some embodiments, hydrophilic elements 67, 69 on electrodes 12 and 14 may increase the tendency for evolved gases to migrate to hydrophobic portions, such as hydrophobic pathways 18, of separator 16. In one embodiment, hydrophilic elements 67, 69 may cover the surface of electrodes 12, 14. In another embodiments, hydrophilic elements 67, 69 may partially cover the surface of electrodes 12, 14, for example, as strips or any other shape. In another embodiment, hydrophilic elements 67, 69 may be applied to separator 16 with any shape or area, e.g. strips, to enhance the hydrophilicity of a portion of separator 16.

FIG. 3 depicts a graph 30 of discharge capacity as a function of cycle number of an embodiment of the present disclosure. The y-axis depicts discharge capacity in Amp Hours. The x-axis depicts cycle number. The embodiment depicted in FIG. 3 was run at a C/2 rate for a first set of about 100 cycles. The cell was then cycled at a 1C charge and 1C discharge rate, with no reset cycles for about the next 300 cycles. FIG. 3 shows that embodiments of the present disclosure using hydrophobic pathways maintain a relatively consistent level of discharge capacity for at least 400 cycles. In comparison, an electrochemical cell without hydrophobic pathways may degrade at about 90 cycles.

FIGS. 4A and 4B illustrate various exemplary methods for fabricating separator 16 with hydrophobic pathways 18 according to various embodiments. In the embodiment shown in FIG. 4A, a patterned mask may be overlaid on separator 16 as a template 40 for applying a hydrophobic solution 42 to regions of the separator surface. Template 40 may include openings 41 of various shapes that define where the hydrophobic coating will be applied to the separator. Hydrophobic solution 42 may be applied onto separator 16 overlaid with template 40 to obtain patterned separator 43 with a desired pattern of coating of hydrophobic solution 42. Following final application and drying of the hydrophobic coating 42, patterned separator 43 may be placed into a sintering oven 44. In some embodiments. AGM separator 16 is sintered at 320° C. to 360° C. for 10 minutes to promote adhesion of the hydrophobic coating to the separator 16.

FIG. 4B illustrates an alternative method for creating hydrophobic pathways 18 according to some embodiments. In FIG. 413, thin strips 45 of microporous polypropylene (PP) are stitched onto separator 16 via stitching device 46. The stitching forms hydrophobic patterned separator 47 with propylene strips 45. Patterned separator 56 may be calendared, as shown in view 48 of FIG. 4B, to produce the final separator 49 with hydrophobic pathways 18.

FIGS. 5A and 5B are flowcharts corresponding to the schematic diagrams of FIGS. 4A and 4B respectively. FIG. 5A depicts a method of fabricating a separator of an embodiment of the present disclosure. At step 510, a separator is manufactured. Separator may be an AGM separator.

At step 520, a template is placed on top of the separator. The template may, for example, include line openings spaced evenly apart and running a length of the separator, as shown in FIG. 4A.

At step 530, hydrophobic solution is sprayed onto the separator overlaid with the template. Only those portions of the separator that are exposed at the openings in the template may be coated with hydrophobic solution, and the masked areas may not be coated. When template is removed from the separator, a patterned hydrophobic coating may be formed on the separator. Hydrophobic solution may comprise diluted solution of polytetrafluoroethylene (PTFE) particles suspended in water and surfactants. In some embodiments, the hydrophobic solution may be applied by spraying the solution onto the separator and the template. In some embodiments, more than one coating may be applied. For example, two coatings may be applied with about a thirty minute drying time in between applications. At step 540, the patterned separator may be heat-treated in an oven as described above.

FIG. 5B depicts the method of fabrication depicted in FIG. 4B. At step 550, separator is manufactured, as discussed above. At step 560, thin strips of microporous polypropylene are stitched onto the separator. Microporous polypropylene strips may function as the hydrophobic pathways of separator 16. Separator is then calendared, at step 570, to produce the final separator with hydrophobic pathways 18.

As discussed in various embodiments above, separator 16 may be altered to have hydrophobic areas. The hydrophobic areas may be applied to separator 16 in various ways, including soaking separator 16, coating separator 16 (e.g., spraying, painting, stamping), or mechanically attaching hydrophobic (e.g., stitching, gluing) elements to separator 16. In addition, the degree to which the alterations of separator 16 are hydrophobic may be varied based on the materials that are applied. For example, a soaking, coating, or application of PTFE may be more hydrophobic than a coating of polyvinylchloride. In another embodiment, separator 16 may be altered to have hydrophilic areas. Hydrophilic areas may be formed on separator 16 in similar ways as hydrophobic areas are formed. For example, separator 16 may be soaked in a hydrophilic solution, coated with a hydrophilic solution, or mechanically attached to hydrophilic elements. Hydrophilic alterations of separator 16 may include varying degrees of hydrophilicity based on the materials used. Hydrophilic areas that are formed on separator 16 may further define preferential location of evolved gases generated at the electrodes. Separator 16 may be altered to have both hydrophobic areas and hydrophilic areas formed on it. For example, separator 16 that includes hydrophobic strips, as shown in FIG. 1A, may be also altered such that the non-hydrophobic parts are treated with a coating that increases the hydrophilicity of separator 16. By combining hydrophobic parts and hydrophilic parts, the aqueous solution may be even more likely to be located at the hydrophilic parts and the gases may be more likely to arrive at the hydrophobic parts.

The separator may be a single separator component or a separator system. Separator system may be formed as a composite of multiple layers. FIGS. 6A-6C illustrate alternative exemplary embodiments of a composite separator system 60. FIG. 6A shows an embodiment of a separator 60 comprising two AGM separator layers 61 which may or may not have hydrophobic pathways 18 (not shown) formed thereon. Sandwiched between separators 61 is a layer of PVC separator material 62. PVC separator 62 may or may not have a pattern formed thereon. In some embodiments, PVC separator 62 is a composite of polyvinyl chloride and silica that is microporous, so that it has some degree of hydrophobic properties while being gas permeable and permitting ionic transport. PVC separator 62 provides a surface that facilitates gas transport. Suitable PVC material is available from Daramic or Amersil. In the embodiment shown in FIG. 6A, PVC separator 62 forms a substantially continuous hydrophobic layer between the AGM separator layers, that is nonetheless gas permeable and permits ionic transport. In various embodiments, PVC separator 62 is ribbed or otherwise textured, thus enhancing the structural integrity of the separator system and providing additional pathways for gas migration.

FIG. 6B shows an embodiment of a composite separator 60 comprising two AGM layers 61 that may or may not have hydrophobic pathways (not shown). Sandwiched between separator layers 61 are strips 64 of PVC separator material. FIG. 6C is an alternative embodiment of separator 16 comprising two sinusoidally ribbed PVC separators 62. Sandwiched between PVC separators 62 are strips 66 of AGM separator material that may or may not have hydrophobic pathways (not shown).

It will be apparent to those skilled in the art that various modifications and variations can be made to the disclosed machine implement control system. Other embodiments will be apparent to those skilled in the art from consideration of the specification and practice of the disclosed machine implement control system. It is intended that the specification and examples be considered as exemplary only, with a true scope being indicated by the following claims and their equivalents.

1. An electrochemical cell, comprising:
a positive electrode;
a negative electrode;
a separator disposed between said positive electrode and said negative electrode for providing ionic transport; and
a hydrophobic portion on the separator.

2. The electrochemical cell of claim 1, wherein:
the hydrophobic portion comprises hydrophobic pathways formed on the surface of the separator.

3. The electrochemical cell of claim 1, wherein
the hydrophobic portion comprises the bulk of the separator treated with a hydrophobic solution.

4. The electrochemical cell of claim 1, wherein
the hydrophobic portion comprises a hydrophobic coating.

5. The electrochemical cell of claim 1, wherein
the hydrophobic portion comprises a hydrophobic element mechanically attached to the separator.

6. The electrochemical cell of claim 1, wherein
the hydrophobic portion comprises the separator, wherein the separator is made at least partly out of hydrophobic material.

7. The electrochemical cell of claim 2, wherein:
the hydrophobic pathways are formed at an interface between the separator and the positive electrode or the separator and the negative electrode.

8. The electrochemical cell of claim 2, wherein:
the hydrophobic pathways guide the evolved gases towards one end of the positive electrode or the negative electrode.

9. The electrochemical cell of claim 2, wherein:
the hydrophobic pathways guide oxygen generated on the positive electrode away from the positive electrode.

10. The electrochemical cell of claim 1, wherein:
the hydrophobic pathways are formed through the plane of the separator.

11. The electrochemical cell of claim 1, wherein:
the hydrophobic pathways are made of polytetrafluoroethylene.

12. The electrochemical cell of claim 1, wherein:
the separator comprises an absorptive glass mat separator.

13. The electrochemical cell of claim 1, further comprising:
a hydrophilic portion on the separator.

14. The electrochemical cell of claim 13, wherein:
the hydrophilic portion comprises a hydrophilic coating on the surface of the separator.

15. The electrochemical cell of claim 1, wherein:
the hydrophobic portion comprises a first portion that is more hydrophobic than a second portion.

16. The electrochemical cell of claim 13, wherein:
the hydrophilic portion comprises a first portion that is more hydrophilic than a second portion.

17. A method of forming a separator for use in an electrochemical cell, the method comprising:
manufacturing the separator; and
applying a hydrophobic portion on the separator.

18. The method of claim 10, wherein applying the hydrophobic portion comprises:
masking the separator with a patterned template; and
applying a hydrophobic solution over the masked separator.

19. The method of claim 11, wherein:
the hydrophobic solution comprises a PTFE suspension in water.

20. The method of claim 17, wherein applying the hydrophobic portion comprises:
soaking the separator in a hydrophobic solution.

21. The method of claim 17, wherein applying the hydrophobic portion comprises:
stitching hydrophobic elements to the separator.

22. The method of claim 17, further comprising:
applying a hydrophilic portion to the separator.

23. A separator, comprising:
a hydrophobic portion on the separator.

24. A separator system comprising the separator of claim 23, wherein:
the separator includes an absorptive glass mat separator with a hydrophobic portion, and the separator system further comprises a textured PVC separator.

25. The separator system of claim 24, comprising:
two of the separators, wherein the textured PVC separator is disposed in between the two absorptive glass mat separators.

26. The separator system of claim 24, comprising:
two of the separators, wherein
strips of the textured PVC separator is disposed in between the two absorptive glass mat separators.

27. The separator system of claim 24, comprising:
two textured PVC separators with strips of the separator disposed in between the two textured PVC separators.

28. A storage device, comprising:
a positive electrode;
a negative electrode;
a separator disposed between said positive electrode and said negative electrode for providing ionic transport; and
a hydrophobic portion on the separator.

29. The storage device of claim 28, wherein:
the hydrophobic portion is applied on the separator, or
the hydrophobic portion is a portion of the separator formed out of hydrophobic material.

30. A method of manufacturing an electrochemical cell, the method comprising:
manufacturing a positive electrode;
manufacturing a negative electrode;
manufacturing a separator;
forming a hydrophobic portion on the separator; and
placing the separator between the positive electrode and the negative electrode.

31. The method of claim 30, wherein an enhanced hydrophilic portion is also formed onto the separator in addition to the hydrophobic one.

32. The electrochemical cell of claim 13, wherein the hydrophobic portion comprises hydrophobic pathways formed on the surface of the separator and the hydrophilic portion of the separator is further treated to enhance its wettability.
